(19) United States
(12) Patent Application Publication
(10) Pub. No.: US 2007/0079334 A1
(43) Pub. Date: Apr. 5, 2007

(54) Methods and systems for resolving scheduling conflicts in a video recorder

(76) Inventor: Kenneth Silver, Plainview, NY (US)

Correspondence Address: KENYON & KENYON LLP, 1500 K STREET N.W., SUITE 700, WASHINGTON, DC, 20005, US

(21) Appl. No.: 11/239,157

(22) Filed: Sep. 30, 2005

(51) Int. Cl. H04N 7/173; H04N 5/445; G06F 13/00; G06F 3/00

(52) U.S. Cl. 725/58; 725/39; 725/61; 725/87

(57) ABSTRACT

Systems and methods are used to automatically resolve a conflict between a plurality of time periods of programs to be recorded in a video recorder. An input is received from a user of a plurality of programs to be recorded. It is determined whether time periods during which the plurality of programs are broadcast overlap with each other. If the time periods overlap, the overlapping period of one of the programs are automatically truncated.

### TECHNICAL FIELD

The present invention relates to methods and systems for video recorder usage. In particular, the present invention relates methods and systems for usage of video recorders, which may be known as digital video recorders (DVRs) or personal video recorders (PVRs), and for resolving scheduling conflicts in programs or other time dependent inputs to be recorded.

### BACKGROUND OF THE INVENTION

The use of digital recorders, such as PVRs or DVRs, has been increased with the offering of such recorders by service providers such as cable and satellite companies, in addition to offerings by companies that specialize in such recorders. Further, similar recorders are now offered with certain personal computers, which often allow the recorder offered with the personal computer to be connected to a service such as cable television, allowing the consumer to record programs for subsequent viewing.

The digital recorders are becoming more sophisticated and being offered with advanced features, recording of high definition (HD) programs, allowing the user to watch a program while recording other programs, etc. These recorders make it easy for the user to “time shift” programs, so they may be viewed when the viewer wants to view the program. The recorders may come with built-in devices such as a DVD player and/or a DVD recorder, allowing the user to record programs stored in the memory of the recorder onto a DVD. The DVD can then be played on a DVD player, allowing portability of the recorded programs. The recorders may be incorporated into another unit, such as a cable box or satellite receiver, or may be stand alone units. The recorders may consist of virtual services consisting of a software interface that regulates the use of a shared storage resource, such as a centralized disk farm.

Further, such recorders often come with software that allows a user to program the recorder to record programs while the user is or is not present. Typically, the recorders allow the user to select desired programs for recording, where the user may select the desired programs from a program schedule, or the user may search for desired programs by title, by type of program (e.g., news program, comedy, sports, etc.) or otherwise.

The recorder will usually set the time and channel of a program to be recorded from a program schedule, which may be published by a cable company or other service provider, or may be downloaded or otherwise obtained. Traditionally, such schedules have been set up in half hour blocks. Typically, a program would start and end on an hour or half hour, and the recorder would thus be set to record desired programs starting and ending on the particular hour or half hour. Special events, such as live sporting events, may often have an undefined end time.

Certain broadcasters of programming have introduced modified program schedules which appear to be designed to hinder recorder users from taking advantage of the recorder's automated features. The time slots have been lengthened or shortened by for certain programs. Typically, the length of the program itself has not changed, but instead the different length is changed by adjusting the number of commercials.

This has created the problem for recorder users, where the user may face an overlap between two programs the user wants to record. For example, the user may want to record a program that typically would start at 8:00 p.m. and finish at 8:30 p.m. on a first channel, and record a second program that typically would start at 8:30 p.m. and finish at 9:00 p.m. on a second channel. If the broadcaster adjusts the end time of the second program to 8:32, for example, and this information is put in the schedule, typically the software for the recorder would see the conflict, and require the user to select one of the two programs for recording, but would not allow the user to select both programs for recording. The recorder may allow the user to manually set the start and end times for each program on each channel, so that the user may record both programs, and select to miss the end of the first program, or miss the start of the second program. However, this typically requires many keystrokes for the user, and does not provide the ease of use of automatically selecting programs for recording.

### SUMMARY OF THE INVENTION

Systems and methods of the present invention are used to automatically resolve a conflict between a plurality of time periods of programs to be recorded in a video recorder. An input is received from a user of a plurality of programs to be recorded. It is determined whether time periods during which the plurality of programs are broadcast overlap with each other. If the time periods overlap, the overlapping period of one of the programs is automatically truncated.

### BRIEF DESCRIPTION OF THE DRAWINGS

FIG. 1 is a block diagram in accordance with an embodiment of the present invention.

FIG. 2 is a block diagram in accordance with an embodiment of the present invention.

FIG. 3 illustrates a scheduling conflict in conjunction with embodiments of the present invention.

FIG. 4 illustrates a programming interface in accordance with embodiments of the present invention.

FIG. 5 illustrates a programming interface in accordance with embodiments of the present invention.

FIG. 6 illustrates a programming interface in accordance with embodiments of the present invention.

FIG. 7 is illustrates a flowchart in accordance with embodiments of the present invention.

### DETAILED DESCRIPTION

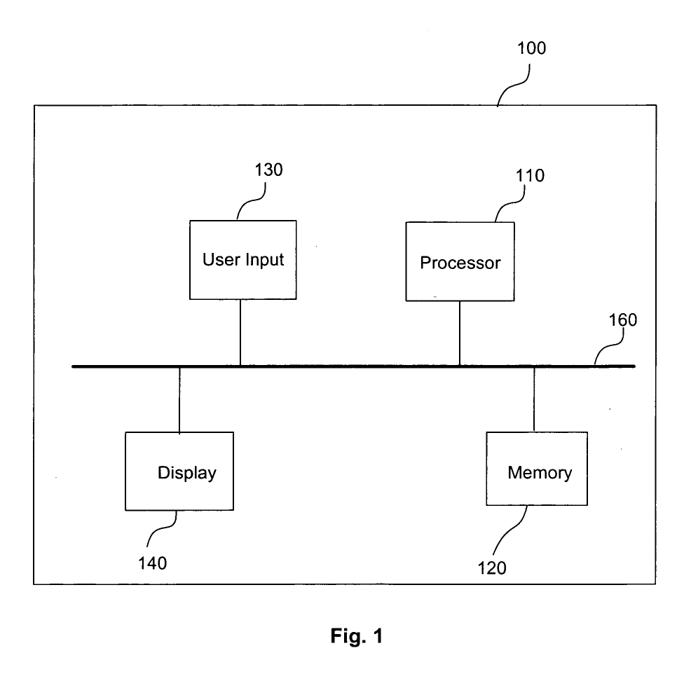

FIG. 1 depicts a block diagram of an embodiment of the present invention. Computing device 100 is suitable for use with the present invention. The computing device 100 may include a processor 110, a memory 120, a user input 130 and a display 140. The memory 120 may contain software to be run in conjunction with processor 110, and may cause images to be displayed on display 140. The software may be specifically designed to cause computing device 100 to implement the present invention. Computing device 100 may be one of various types of computing devices, such as a workstation, a personal computer, a server, a headend or cable box in a cable system, or any other type of computing device.

The processor 110 may be a general-purpose microprocessor, such as a Pentium series microprocessor manufactured by the Intel Corporation of Santa Clara, Calif. In another embodiment, the processor 110 can be an Application Specific Integrated Circuit (ASIC), which has been designed to implement in its hardware and/or firmware at least a part of a method in accordance with embodiments of the present invention.

Memory 120 can be any device capable of storing analog or digital information, such as a hard disk, Random Access Memory (RAM), Read Only Memory (ROM), flash memory, a compact disk, a magnetic tape, a floppy disk, and any combination thereof, for example.

User input 130 can be any type of input device, such as a keyboard, keypad, pointing device, microphone, mouse, wired or wireless remote control, touch pad, touch screen, a port(s) to attach other input devices, voice recognition software, etc. Any type of input device will function in accordance with embodiments of the present invention.

The display 140 can be any type of display or screen that is capable of displaying images. For example, the display may be a CRT or LCD monitor, a heads-up display, a television, etc. The display 140 may be structurally included as part of the electronic device, or may be physically separated from but connected with the other components of device 100, such as a monitor in a desktop computer or a television.

The computing device will include functionality allowing it to function as a video recorder, which will record video programs, including audio portions of the video programs. The video recorder may be known as a DVR or PVR, and may be provided to a user through a service provider such as a cable television company, a satellite company, or a provider of stand alone recorders. The video recorder may be a stand alone unit, or may be integrated into another device, such as a cable or satellite box, a computer such as a personal computer, or another type of computing device. The video recorder typically will be provided with software providing a user with video recording features. Further details of the video recorder are described below.

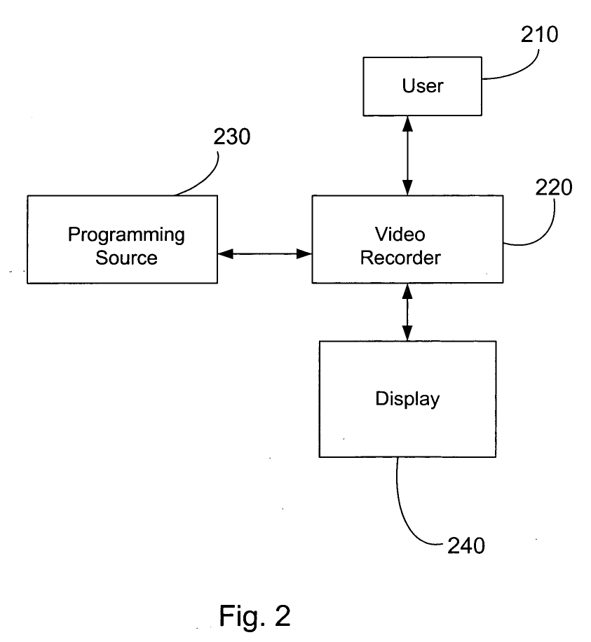

FIG. 2 illustrates a typical configuration of the computing device of FIG. 1 in accordance with an embodiment of the present invention. A user 210 will access the video recorder 220 to set up recording of programs, to watch recorded programs, and to access other functionality. The video recorder will typically be connected to a source of programming 230, which may be cable television, satellite television or some other source. The user can access the video recorder 220 by use of an input device such as a keyboard, remote control, keypad, etc. as described above.

The user will be able to view a programming interface on display 240 in accordance with known techniques, allowing the user to select programs to be recorded. The interface may allow the user to select multiple programs to be recorded at different times. The interface may access program schedules to display to the user and allow the user to select one or more programs from the program schedules for recording. The source of the programming schedules may be from the cable or satellite company, from the Internet, or from other sources as known in the art. The programs may be accessed for recording with a tuner (not shown) that is incorporated into the cable box, satellite box, television, etc. to be recorded at times selected by the user

If the user selects more than one program to be recorded, and the programs have overlapping time schedules, the interface may allow the user to select one of the two programs to be recorded to resolve the conflict. The present invention is generally applicable to recorders that utilize one tuner for recording programs. If two or more tuners are present, then the conflict issue may not arise, as the two tuners may be used to record two overlapping programs. However, it is possible that multi-tuner recorders could be programmed in a way that causes conflicts, in which case the present invention is applicable. Typical prior art systems would require the user to select one of the two programs for recording, but not both, or would require the user to manually create programming schedules to record both programs, while not recording the overlapping portion of one of the programs, through a complicated series of menu choices and/or key strokes.

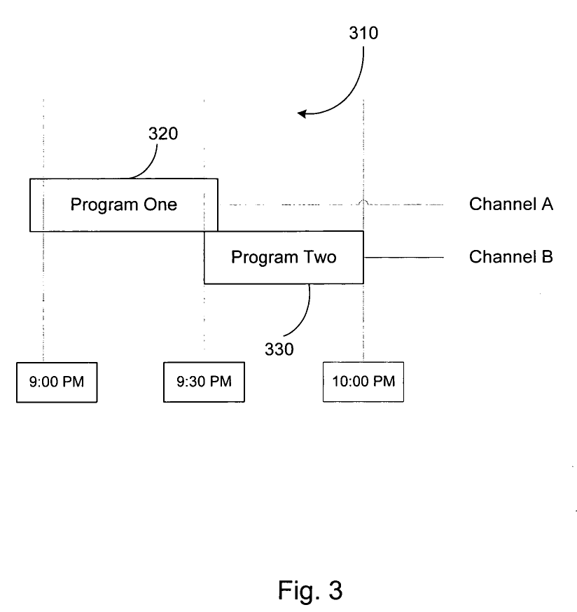

FIG. 3 illustrates a programming schedule that may be displayed on a programming interface 310 on display 240 in conjunction with embodiments of the present invention. The programming schedule illustrates two programs that have been selected by a user for recording, Program One 320 and Program Two 330. Program One is shown as starting at 9:00 PM on channel A and ending at a time slightly after 9:30 PM, such as 9:32 PM, while Program Two starts at 9:30 PM on channel B and ends at 10:00 PM. There is a two minute overlap period from 9:30 PM till 9:32 PM when both programs are running. Accordingly, embodiments of the present invention will automatically provide a resolution for this problem, as further explained below.

When a scheduling conflict of overlapping programs arises such as described above, embodiments of the present invention automatically present the user with the option to record both programs. If this option is selected by the user, the programming schedule may be automatically re-calculated to resolve the programming conflict by truncating the overlapping portion of one of the two programs, with the truncated portion not being recorded. Additionally, embodiments of the present invention may perform the truncation without presenting the option to record both programs, but simply upon receiving an indication from the user to record the programs and determining that they have overlapping time periods.

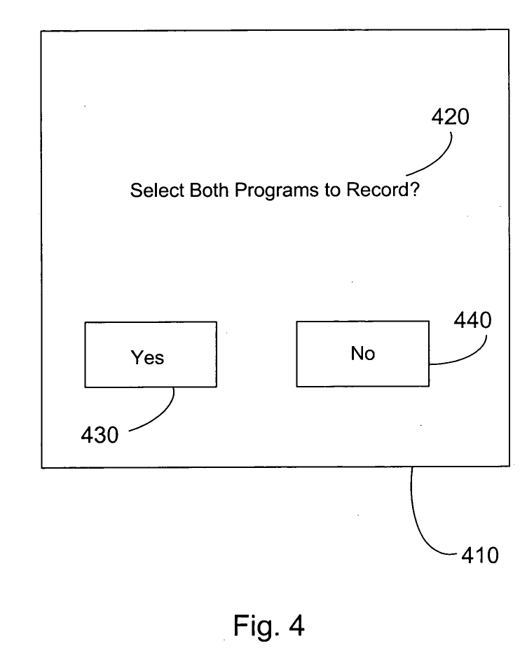

FIG. 4 illustrates a programming interface 410 that may be displayed on the display after the user has selected two programs for recording that have overlapping portions as described above. The programming interface may display the query 420 “Select Both Programs to Record”, or a similar indication, along with options 430, 440, allowing the user to select Yes or No. If the user selects “Yes” using an input device as described above, embodiments of the present invention will truncate a portion of one of the two programs, and the truncated portion will not be recorded.

Certain embodiments of the present invention will automatically truncate the end portion of the first program, such as Program One described above. Thus, in the example described in conjunction with FIG. 3, these embodiments would automatically truncate Program One at 9:30, so that the recording of Program One would stop at 9:30 and the recording of Program Two would start at 9:30.

Other embodiments of the invention would automatically truncate the beginning of Program Two, and record Program One until it ends. Thus, in the example described in conjunction with FIG. 3, these embodiments would automatically record Program One until it ends at 9:32 PM, and truncate the beginning of Program Two until 9:32, so that Program Two would not start being recorded until 9:32 PM, in this example.

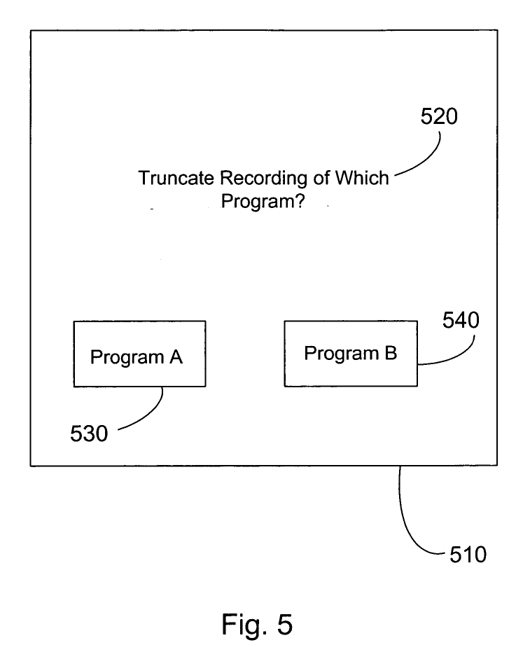

Further, other embodiments of the invention may present the user with the option of which program to truncate. FIG. 5 illustrates a programming interface 510 that may be displayed on the display after the user has selected two programs for recording that have overlapping portions as described above. The programming interface may display the query 520 “Truncate Recording of Which Program?”, or a similar indication, along with options 530, 540, allowing the user to select Program A or Program B. Any such interface could be used which presents the user with an option of which program to truncate.

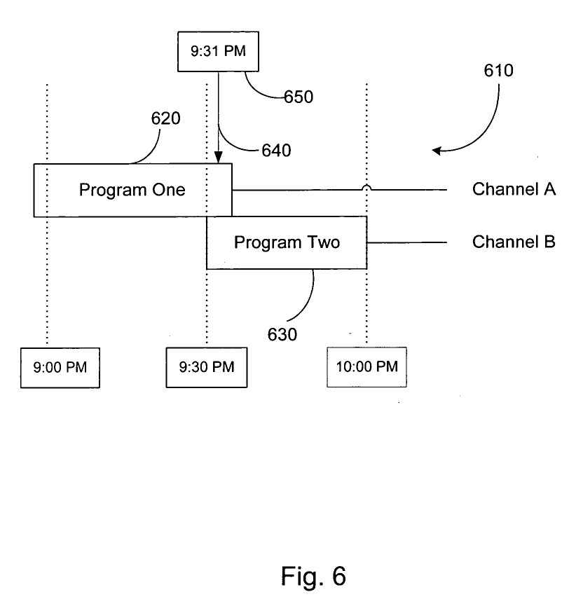

If the user selects the option to record both programs, embodiments of the invention may automatically truncate the overlapping portion of either program, or may present the user with the option of which program to truncate as described above. In accordance with other embodiments of the present invention, the user may also be presented with a programming interface 610 as illustrated in FIG. 6. These embodiments may allow the user to select the precise time the truncation occurs, which may be any time within the time period that the programs overlap. The user may be able to enter a time for the truncation to occur, as well as which program should be truncated. The user may be able to simply enter a time for truncation with the interface selecting which program to truncate or may enter a time and program for truncation.

As illustrated in FIG. 6, the programming interface 610 may include representations of the two programs 610 and 620, and a graphical truncation indicator 640 that the user can manipulate to select a desired truncation time in the overlap time period. The truncation indicator 640 may be an arrow as illustrated or another graphical indicator. The user may be able to move the truncation indicator by any known method, such as dragging and dropping. The truncation indicator may include a time indicator 650, which may automatically change when the user moves the truncation indicator 640. Alternatively, the user may be able to enter a time into the time indicator 650, which may automatically move the truncation indicator 650. Movement of the truncation indicator may be indicated by graphical changes on the representations of one or both of the programs. The user may be presented with an option (not shown) to accept the truncated time, as well as which program is to be truncated, or to truncate both programs.

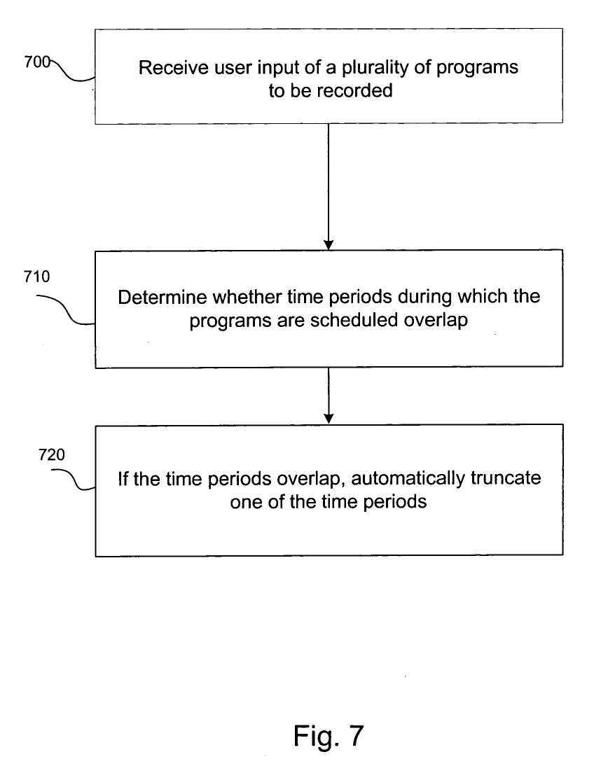

FIG. 7 illustrates a flowchart in accordance with embodiments of the present invention. In step 700, a user input is received indicating a plurality of programs to be recorded on a video recorder, as described above.

In step 710, it is determined whether time periods during which the programs are scheduled overlap with each other. In step 720, if the time periods overlap with each other, one of the overlapping time periods of the programs is automatically truncated. This truncation can occur by any of the methods described herein.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A method of automatically resolving a conflict between a plurality of time periods of programs to be recorded in a video recorder, comprising:
receiving input from a user of a plurality of programs to be recorded;
determining whether time periods during which the plurality of programs are scheduled overlap with each other; and
if the time periods overlap, automatically truncating the overlapping time period of one of the programs for recording.

2. The method of claim 1, wherein automatically truncating the overlapping period of one of the programs comprises truncating an end period of the one of the programs that begins first in time.

3. The method of claim 1, wherein automatically truncating the overlapping period of one of the programs comprises truncating a beginning period of the one of the programs that begins second in time.

4. The method of claim 1, wherein automatically truncating the overlapping period of one of the programs comprises presenting to the user an option to record both programs, and upon receiving an indication from the user to record both programs, automatically truncating the overlapping period of one of the programs.

5. The method of claim 1, wherein automatically truncating the overlapping period of one of the programs comprises presenting the user with an option of which one of the programs to truncate, receiving from the user an indication of which one of the programs to truncate, and automatically truncating the overlapping period of the indicated program.

6. The method of claim 1, wherein automatically truncating the overlapping period of one of the programs comprises displaying a visual representation of the overlapping programs to the user illustrating an overlap period, displaying a truncation indicator adjacent to the overlap period that is manipulatable by the user to select a time for truncation, receiving an indication from the user manipulating the truncation indicator of a desired truncation time, and automatically truncating the overlapping period of one or both of the programs at the desired truncation time.

7. The method of claim 6, further comprising displaying a desired truncation time adjacent to the truncation indicator.

8. The method of claim 7, wherein the desired time automatically changes upon manipulation of the truncation indicator by the user.

9. A system that automatically resolves a conflict between a plurality of time periods of programs to be recorded in a video recorder, comprising:
a processor;
a memory to store instructions to be executed by the processor, the instructions including instructions to:
receive input from a user of a plurality of programs to be recorded;
determine whether time periods during which the plurality of programs are broadcast overlap with each other; and
if the time periods overlap, automatically truncate the overlapping period of one of the programs.

10. The system of claim 9, wherein the instructions to automatically truncate the overlapping period of one of the programs comprise instructions to truncate an end period of the one of the programs that begins first in time.

11. The system of claim 9, wherein the instructions to automatically truncate the overlapping period of one of the programs comprises instructions to truncate a beginning period of the one of the programs that begins second in time.

12. The system of claim 9, wherein the instructions to automatically truncate the overlapping period of one of the programs comprises instructions to present to the user an option to record both programs, and upon receiving an indication from the user to record both programs, to automatically truncate the overlapping period of one of the programs.

13. The system of claim 9, wherein the instructions to automatically truncate the overlapping period of one of the programs comprises instructions to present the user with an option of which one of the programs to truncate, receive from the user an indication of which one of the programs to truncate, and automatically truncate the overlapping period of the indicated program.

14. The system of claim 9, wherein the instructions to automatically truncate the overlapping period of one of the programs comprises instructions to display a visual representation of the overlapping programs to the user illustrating an overlap period, display a truncation indicator adjacent to the overlap period that is manipulatable by the user to select a time for truncation, receive an indication from the user manipulating the truncation indicator of a desired truncation time, and automatically truncate the overlapping period of one or both of the programs at the desired truncation time.

15. The system of claim 14, wherein the instructions further comprise instructions to displaying a desired truncation time adjacent to the truncation indicator.

16. The system of claim 15, wherein the instructions further comprise instructions to automatically change the desired time upon manipulation of the truncation indicator by the user.

17. A machine-readable medium having stored thereon a plurality of executable instructions for automatically resolving a conflict between a plurality of time periods of programs to be recorded in a video recorder, the plurality of instructions comprising instructions to:
receive input from a user of a plurality of programs to be recorded;
determine whether time periods during which the plurality of programs are broadcast overlap with each other; and
if the time periods overlap, automatically truncate the overlapping period of one of the programs.

18. The machine-readable medium of claim 17, wherein the instructions to automatically truncate the overlapping period of one of the programs comprises instructions to display a visual representation of the overlapping programs to the user illustrating an overlap period, display a truncation indicator adjacent to the overlap period that is manipulatable by the user to select a time for truncation, receive an indication from the user manipulating the truncation indicator of a desired truncation time, and automatically truncate the overlapping period of one or both of the programs at the desired truncation time.

19. The machine-readable medium of claim 18, wherein the instructions further comprise instructions to displaying a desired truncation time adjacent to the truncation indicator.

20. The machine-readable medium of claim 19, wherein the instructions further comprise instructions to automatically change the desired time upon manipulation of the truncation indicator by the user.
